(19) United States
(12) Patent Application Publication
(10) Pub. No.: US 2004/0255294 A1
(43) Pub. Date: Dec. 16, 2004

(54) System and method for hierarchical loading of EJB implementations

(75) Inventor: Mark Spotwood, Newton Center, MA (US)

Correspondence Address: FLIESLER MEYER, LLP, FOUR EMBARCADERO CENTER, SUITE 400, SAN FRANCISCO, CA, 94111, US

(73) Assignee: BEA SYSTEMS, INC., San Jose, CA (US)

(21) Appl. No.: 10/777,362

(22) Filed: Feb. 12, 2004

Related U.S. Application Data
(60) Provisional application No. 60/446,878, filed on Feb. 12, 2003.

(51) Int. Cl. G06F 9/445

(52) U.S. Cl. 717/176; 717/171; 717/178

(57) ABSTRACT

A system and method for allowing individual software modules for an Enterprise Java Bean (EJB) software application to be reloaded in memory without forcing other modules to be reloaded at the same time. Such reloadable modules address the problem of not being able to reload a module without reloading all classes in the application. In accordance with one embodiment the root classloader and webapp classloader are reorganized, and the individual modules placed in their own classloader. This allows the developer to define their classloader organization according to their particular needs. In this way the system can reload the EJB implementation (impl) class without affecting the rest of the application. The system or a developer can also reload an individual EJB module without affecting the rest of the application.

### CLAIM OF PRIORITY

This application claims priority from U.S. Provisional Application No. 60/446,878, entitled “SYSTEM AND METHOD FOR HIERARCHICAL LOADING OF EJB IMPLEMENTATIONS”, by Mark Spotswood, filed Feb. 12, 2003 (Atty. Docket No. BEAS-01313US0), and which application is incorporated herein by reference.

### CROSS-REFERENCES

This application is related to U.S. Provisional Patent Application No. 60/446,836, entitled “SYSTEM AND METHOD FOR USING CLASSLOADER HIERARCHY TO LOAD SOFTWARE MODULES”; by Mark Spotswood, filed Feb. 12, 2003 (Atty. Docket No. BEAS-01312US0); and to U.S. patent application No. ______, entitled “SYSTEM AND METHOD FOR USING CLASSLOADER HIERARCHY TO LOAD SOFTWARE MODULES”, by Mark Spotswood, filed Feb. 12, 2004 (Atty Docket No. BEAS-01312US1), both of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to computer software application execution, and particularly to a system and method for allowing individual EJB implementations to be reloaded in memory.

### BACKGROUND

Many of today's computer software applications are written in the Java programming language. Java differs from other programming languages in that programs written in Java are generally run in a virtual machine environment. Once a Java program is written, it may then be compiled into byte-code, interpreted by the Java Virtual Machine (JVM) into hardware instructions, and executed on a variety of different platforms. This methodology allows Java to follow the “write once, run anywhere” paradigm. Components of Java programs are stored in modular components referred to as class files. A class may be defined as a collection of data and methods that operate on that data. A class is able to inherit properties (and methods) from any other class which is found above it in the hierarchy of inter-related classes for a particular program. The class located at the highest tier in the hierarchy is commonly referred to as the “parent class” or “superclass”, while an inheriting class located on a lower tier is commonly referred to as the “child class” or “subclass”.

Classloaders are a fundamental component of the Java language. A classloader is a part of the Java virtual machine (JVM) that loads classes into memory; and is the class responsible for finding and loading class files at run time. A successful Java programmer needs to understand classloaders and their behavior. Classloaders are arranged in a hierarchy with parent classloaders and child classloaders. The relationship between parent and child classloaders is analogous to the object relationship of superclasses and subclasses.

The bootstrap classloader is the root of the Java classloader hierarchy. The Java virtual machine (JVM) creates the bootstrap classloader, which loads the Java development kit (JDK) internal classes and java.* packages included in the JVM. (For example, the bootstrap classloader loads java.lang.String).

The extensions classloader is a child of the bootstrap classloader. The extensions classloader loads any Java Archive (JAR) files placed in the extensions directory of the JDK. This is a convenient means to extending the JDK without adding entries to the classpath. However, anything in the extensions directory must be self-contained and can only refer to classes in the extensions directory or JDK classes.

The system classpath classloader extends the JDK extensions classloader. The system classpath classloader loads the classes from the classpath of the JVM. Application-specific classloaders (including, in the case of the BEA WebLogic product, WebLogic Server classloaders) are children of the system classpath classloader.

As used herein the term “system classloader” is used to refer to a type of classloader which is frequently referred to as an “application classloader” in contexts outside of the BEA WebLogic Server product. When discussing classloaders in WebLogic Server, the term “system” is used to differentiate those classloaders from classloaders related to J2EE applications (which BEA WebLogic typically refers to as “application classloaders”).

Classloaders typically use a delegation model when loading a class. The classloader implementation first checks to see if the requested class has already been loaded. This class verification improves performance in that the cached memory copy is used instead of repeated loading of a class from disk or permanent storage. If the class is not found in memory, the current classloader asks its parent for the class. Only if the parent cannot load the class does the classloader then attempt to load the class. If a class exists in both the parent and child classloaders, the parent version is loaded. This delegation model is followed to avoid multiple copies of the same form being loaded. Multiple copies of the same class can lead to a ClassCastException.

As mentioned above, classloaders ask their parent classloader to load a class before attempting to load the class themselves. In a product such as BEA WebLogic, classloaders that are associated with Web applications can also be configured to check locally first before asking their parent for the class. This allows Web applications to use their own versions of third-party classes, which might also be used as part of the WebLogic Server product.

At run-time, application classes are loaded into the JVM for execution by a hierarchy of one or more classloaders. This (sub)hierarchy is below the system classloader described above. The simplest design of this classloader hierarchy includes one root classloader which loads all the modules and individual class files which an application requires. However, this design is very inefficient, in that reloading a single class file or module requires the reloading of all class files or modules previously loaded by that classloader.

A second hierarchical configuration loads the majority of the class files required by the application into the root classloader and allows only web modules (commonly packaged as “.WAR” archives) to be loaded by classloaders one level subordinate to the root classloader. However, this implementation does not address the fact that the set of all modules (for example Enterprise Java Beans or EJBs) utilized by an application is still required to be loaded by a single classloader, and, therefore reloaded as a set. The problems of both of these typical hierarchical organizations include:

1. A module, for example an EJB, cannot be reloaded without reloading all classes in the application, which effectively means having to reinitialize (reinit) the entire application.

2. There is no namespace separation between modules (for example between EJB's).

A mechanism that provides more granular control over the classloader hierarchy structure and the associated interrelationships between classes would help address these problems, and give the developer better control over the reloading and namespace separation of individual modules, including EJB's.

### SUMMARY OF THE INVENTION

The present invention provides a system and method for allowing individual software modules to be reloaded in memory without forcing other modules to be reloaded at the same time. Such “reloadable modules” address the problem of not being able to reload a module or component without reloading all classes in the application. In accordance with one embodiment the root classloader and webapp classloader levels are reorganized, and the individual implementation classes placed in their own classloader. This allows the developer to define their classloader organization according to their particular needs. In this way the system can reload a component or class without affecting the rest of the application. The developer has the ability to organize the top two levels (i.e. the root and webapp levels) on a per-module basis as they see fit. The third level is organized automatically. In accordance with one embodiment, a developer can declare the classloader hierarchy in an application deployment descriptor (for example a weblogic-application.xml file) as follows:

<!ELEMENT classloader-structure (module-ref*,
classloader-structure*)>
<!ELEMENT module-ref (module-uri)>
<!ELEMENT module-uri (#PCDATA)>

### BRIEF DESCRIPTION OF THE DRAWINGS

FIG. 1 illustrates a standard classloader structure commonly utilized by applications.

FIG. 2 illustrates a classloader structure in accordance with one embodiment of the invention.

FIG. 3 illustrates a classloader hierarchy example in accordance with an embodiment of the invention.

FIG. 4 illustrates a default classloader hierarchy in accordance with an embodiment of the invention.

FIG. 5 illustrates a classloader hierarchy generated as a result of parsing a classloader structure in accordance with an embodiment of the invention.

FIG. 6 is a flowchart showing the steps used to parse a classloader hierarchy in accordance with an embodiment of the invention.

FIG. 7 illustrates a classloader hierarchy for a simple EJB module in accordance with an embodiment of the invention.

FIG. 8 is a flowchart showing the steps used to reload EJB implementations in a classloader hierarchy in accordance with an embodiment of the invention.

### DETAILED DESCRIPTION

The Java 2 Platform, Enterprise Edition (J2EE) defines a standard for developing component-based enterprise applications. Enterprise JavaBeans (EJBs) are the server-side components for J2EE. EJBs allow for development of distributed, portable applications based on Java. JavaServer Page (JSP) components allow for creating web pages that display dynamically-generated content. JSP pages are compiled into servlets and may call EJBs. Additional information about J2EE, EJBs and JSPs can be found in the J2EE specifications published by Sun Microsystems, Inc., and accessible on the Web at http://java.sun.com/j2ee/index.jsp, at http://java.sun.com/products/ejb/, and at http://java.sun.com/products/jsp/ respectively, each of which are incorporated herein by reference.

The present invention provides a system and method for allowing individual software modules or components, such as J2EE modules, to be reloaded in memory without forcing other modules to be reloaded at the same time. Such “reloadable modules” address the problem of not being able to reload, for example, an EJB without reloading all classes in the application. In accordance with one embodiment the root classloader and webapp classloader levels are reorganized, and the individual module (e.g. EJB implementation classes) placed in their own classloader. In this way the system can reload the Enterprise Java Bean (EJB) implementation (impl) class without affecting the rest of the application. The system or a developer can also reload an individual EJB module without affecting the rest of the application. The developer has the ability to organize the root and webapp levels on a per-module basis, as they see fit. The third level is organized automatically.

One embodiment of the present invention provides the capability for customization of the classloader hierarchy for use with an application server, such as the WebLogic server product or another type of application server. A deployment descriptor or control file can include a “classloader-structure” stanza which is then interpreted by an application component, such as an application container constructor, either singularly or as recursive nested references to modules and/or individual class files. A hierarchy (a “tree”) of associated classloaders is then built. As the application container is constructed, the application server traverses the tree specified in the control file and builds a parent-child relationship between the tiers of selected classloaders, thus establishing the hierarchy.

In another embodiment, a single web module, an EJB module, an EJB implementation class, or a combination of these elements may be placed in a plurality of subordinate classloaders. Subsequently, one may reload an update to any of these objects without reloading other application modules, thus preserving time, effort, and application stability.

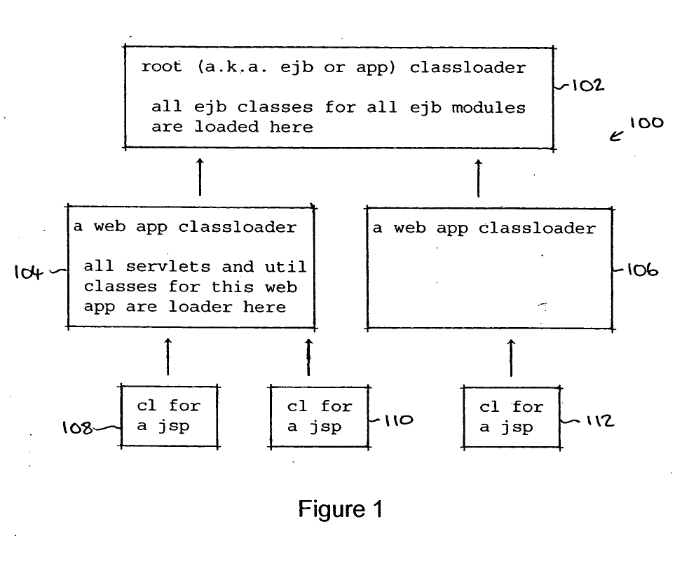

Typically, the standard classloader organization for an application includes a root classloader for all EJBs in the application. For each web application there is a separate classloader that is a child of the application root classloader (sometimes referred to as the EJB classloader). Also, each Java Server Page (JSP) has its own classloader which is a child of its web application's classloader. The standard classloader organization 100 for an application appears as shown in FIG. 1, and includes a root classloader 102, a set of Web app classloaders 104, 106, and classes 108, 110, 112 for the respective Web apps. This is an optimal organization for most users because:

1. A developer (or the system) can reload JSPs individually.

2. Webapps can be reloaded individually.

3. Webapp code can directly reference classes in EJB modules. This allows us to pass EJB parameters by reference rather than by value.

4. A Developer (or the system) can perform namespace separation between web applications.

5. Modules that reference EJBs in other modules aren't required to include the interfaces for those EJBs since they are visible in the root classloader.

However, the downside of the standard organization includes that:

1. The developer cannot reload an EJB without reloading all classes in the application (which effectively means reinitializing the entire app

2. The system doesn't allow namespace separation between EJB modules.

Reloadable modules address the problem of being able to reload a module or EJB without reloading all classes in the application, at the expense of being able to directly reference classes in EJB modules.

In accordance with one embodiment of the invention, the root classloader and webapp classloader levels (the top two classloader levels shown in FIG. 1) are reorganized at the module level, and the individual EJB implementation classes are put in their own classloader.

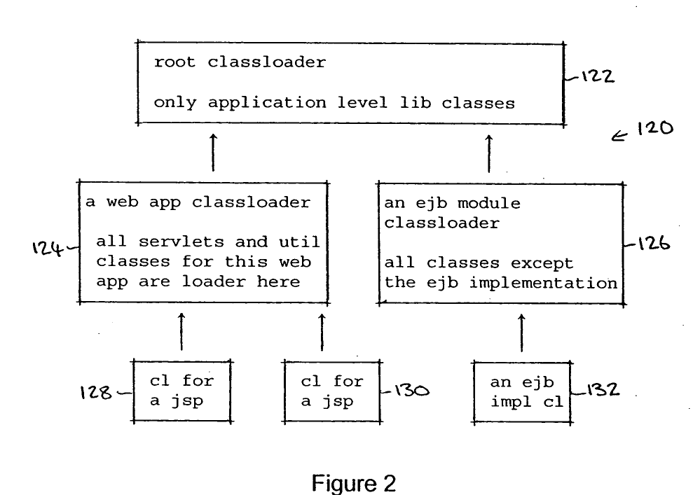

FIG. 2 illustrates the resulting classloader architecture 120, in which the root classloader 122 contains only application level library classes. A Web app classloader 124 contains all servlet and utility classes for this Web app, while an EJB module classloader 126 contains all classes except the EJB implementation. A third level contains the classes for the JSP's 128, 130, 132. With this architecture, a developer can reload the EJB impl class without affecting the rest of the application. They can also reload an individual EJB module without affecting the rest of the application. These features provides the developer with the ability to organize the first two levels on a per-module basis according to their needs. The third level is done automatically.

Application Classloading

In a typical application server environment, for example a WebLogic Server implementation, classloading is centered on the concept of an application. An application is normally packaged in an Enterprise Archive (EAR) file containing application classes. Everything within an EAR file is considered part of the same application. The following may be part of an EAR or can be loaded as standalone applications:

An Enterprise JavaBean (EJB) JAR file;

A Web Application WAR file; and/or,

A Resource Adapter RAR file.

If a developer deploys an EJB JAR file and a Web Application WAR file separately, they are considered two applications. If they are deployed together within an EAR file, they are considered a single (i.e. one) application. The developer can deploy components together in an EAR file for them to be considered part of the same application. If the developer needs to use resource adapter-specific classes with Web components (for example, an EJB or Web application), they must bundle these classes in the corresponding component's archive file (for example, the JAR file for EJBs or the WAR file for Web applications).

Every application receives its own classloader hierarchy. The parent of this hierarchy is the system classpath classloader. This isolates applications so that application A cannot see the classloaders or classes of application B. In classloaders, no sibling or friend concepts exist. Application code only has visibility to classes loaded by the classloader associated with the application (or component), and classes that are loaded by classloaders that are ancestors of the application (or component) classloader. This allows a server such as the WebLogic Server to host multiple isolated applications within the same JVM.

Application Classloader Hierarchy

WebLogic Server automatically creates a hierarchy of classloaders when an application is deployed. The root classloader in this hierarchy loads any EJB JAR files in the application. A child classloader is created for each Web Application WAR file. Because it is common for Web Applications to call EJBs, the application classloader architecture allows JavaServer Page (JSP) files and servlets to see the EJB interfaces in their parent classloader. This architecture also allows Web Applications to be redeployed without redeploying the EJB tier. In practice, it is more common to change JSP files and servlets than to change the EJB tier.

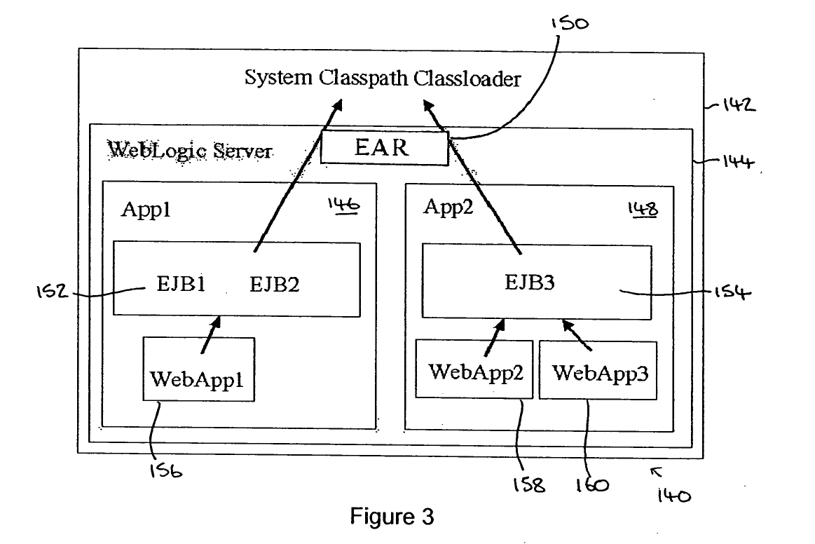

FIG. 3 illustrates this WebLogic Server application classloading concept. If the application includes servlets and JSPs that use EJBs, the developer should:

Package the servlets and JSPs in a WAR file.

Package the enterprise beans in an EJB JAR file.

Package the WAR and JAR files in an EAR file.

Deploy the EAR file.

Although the developer could deploy the WAR and JAR files separately, deploying them together in an EAR file 150 produces a classloader arrangement that allows the servlets and JSPs to find the EJB classes. If they deploy the WAR and JAR files separately, the server 144 (in this instance the WebLogic Server) creates sibling classloaders 146, 148 for them. This means that they must include the EJB home and remote interfaces in the WAR file, and the server must use the RMI stub and skeleton classes for EJB calls, just as it does when EJB clients and implementation classes are in different JVMs. The Web application classloader 152, 154 contains all classes for the Web application except for the JSP class. The JSP class 156, 158, 160 obtains its own classloader, which is a child of the Web application classloader. This allows JSPs to be individually reloaded.

Custom Module Classloader Hierarchies

In accordance with an embodiment of the invention, a developer can create custom classloader hierarchies for an application, which allows for better control over class visibility and reloadability. They achieve this by defining a classloader-structure element in the servers control file or deployment descriptor file (which for example in WebLogic is the weblogic-application.xml file).

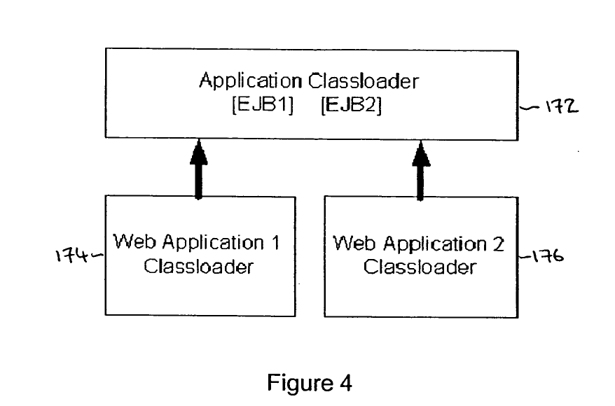

FIG. 4 illustrates how classloaders are organized by default for applications in a WebLogic implementation. An application level classloader exists where all EJB classes are loaded. For each Web module 172, there is a separate child classloader 174, 176 for the classes of that module. (For simplicity, JSP classloaders are not shown in FIG. 4). This hierarchy is optimal for most applications, because it allows call-by-reference semantics when the developer invokes on EJBs. It also allows Web modules to be independently reloaded without affecting other modules. Further, it allows code running in one of the Web modules to load classes from any of the EJB modules. This is convenient, as it can prevent a Web module from including the interfaces for EJBs that it uses. The ability to create custom module classloaders provides a mechanism to declare alternate classloader organizations that allow the following:

Reloading of individual EJB modules independently.

Reloading of groups of modules to be reloaded together.

Reversing the parent child relationship between specific Web modules and EJB modules.

Namespace separation between EJB modules.

Declaring the Classloader Hierarchy

As mentioned above, in accordance with one embodiment, the developer can declare the classloader hierarchy in the application deployment descriptor file, for example in a WebLogic environment the weblogic-application.xml file. The document type definition (DTD) for this declaration is as follows:

<!ELEMENT classloader-structure (module-ref*,
classloader-structure*)>
<!ELEMENT module-ref (module-uri)>
<!ELEMENT module-uri (#PCDATA)>

The top-level element in weblogic-application.xml includes an optional classloader-structure element. If the developer does not specify this element, then the standard classloader is used. Also, if the developer does not include a particular module in the definition, it is assigned a classloader, as in the standard hierarchy, i.e., EJB modules are associated with the application Root classloader and Web Modules have their own classloaders. The classloader-structure element allows for the nesting of classloader-structure stanzas, so that the developer can describe an arbitrary hierarchy of classloaders. The outermost entry indicates the application classloader. For any modules not listed, the standard hierarchy is assumed.

Note that JSP classloaders are not included in this definition scheme. JSPs are always loaded into a classloader that is a child of the classloader associated with the Web module to which it belongs. The following is an example of what a classloader declaration may look like. It will be evident that this example is given for purposes of illustration, and is not intended to limit the scope of the invention in anyway. Other examples maybe evident to one skilled in the art:

```
<classloader-structure>
  <module-ref>
    <module-uri>ejb1.jar</module-uri>
  </module-ref>
  <module-ref>
    <module-uri>web3.war</module-uri>
  </module-ref>
  <classloader-structure>
    <module-ref>
      <module-uri>web1.war</module-uri>
    </module-ref>
  </classloader-structure>
  <classloader-structure>
    <module-ref>
      <module-uri>ejb3.jar</module-uri>
    </module-ref>
    <module-ref>
      <module-uri>web2.war</module-uri>
    </module-uri>
    <classloader>
      <module-ref>
        <module-uri>web3.war</module-uri>
      </module-ref>
    </classloader>
    <classloader>
      <module-ref>
        <module-uri>ejb2.jar</module-uri>
      </module-ref>
    </classloader>
  </classloader>
</classloader>
```

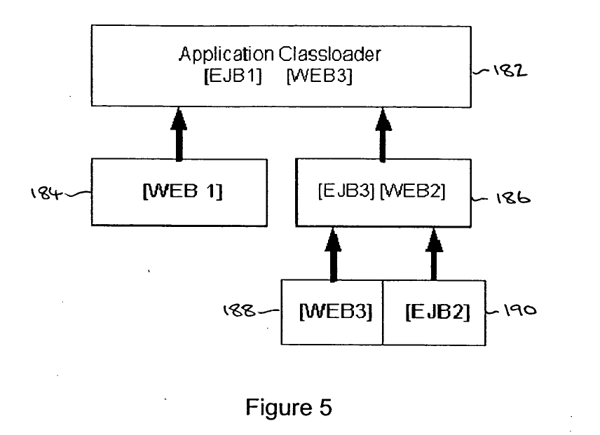

The organization of the nesting in the above classloader declaration indicates the classloader hierarchy. The above stanza can be used to produce a hierarchy such as that illustrated in FIG. 5. In the example shown above, the modules or individual class files, identified by “module-uri” tags, are then retrieved from a storage medium, usually attached to or part of the application server, but in some instance attached to or part of the client environment directly, and loaded into the JVM in the order and according to the relationship hierarchy specified. As the classes are loaded into the JVM, the application server may also compare the content of a module with the content of previously loaded modules prior to its introduction to the application container in order to prevent the introduction of duplicate modules. If the deployment descriptor or control file specifies that duplicate module or duplicate classes are to be loaded, the application server may perform an event-handling task such as returning a message to the output device or terminating the load altogether.

FIG. 5 illustrates a search order that can be used for locating classes not found within the same classloader as the calling module in Java applications. The search proceeds up to a higher level of the tree, but is limited to only those classloaders which are a direct “ancestor” of the calling classloader. Thus, a class or module located in a “sibling” classloader to the classloader containing the calling class or module will not be located. For instance, an EJB module or implementation class 188, 190 might require the use of a method located in a web module in a higher tier 182. The classes and modules co-located in the calling classloader can be searched first. If the required method is not found, the search may proceed to the parent classloader 186 of the classloader which contains the calling class. Each component located in the parent classloader may be searched and, if the method is not found, the search continues further up the hierarchy to the next ancestor classloader 182. Upon locating the desired method within a class file, the calling module can proceed to create an instantiation of the necessary object(s) for execution. However, if a component 188, 190 required the use of a method located in a sibling classloader 184, the limitations of the traditional search method would require the use of Remote Method Invocation (RMI) in order to execute the desired method. One embodiment of the present invention addresses this problem by granting the capability to place classes or modules frequently called by one another on the same branch (or in the same classloader), and therefore, in the same search path, while at the same time allowing the components to be optionally separated into different classloaders to facilitate dynamic reloading.

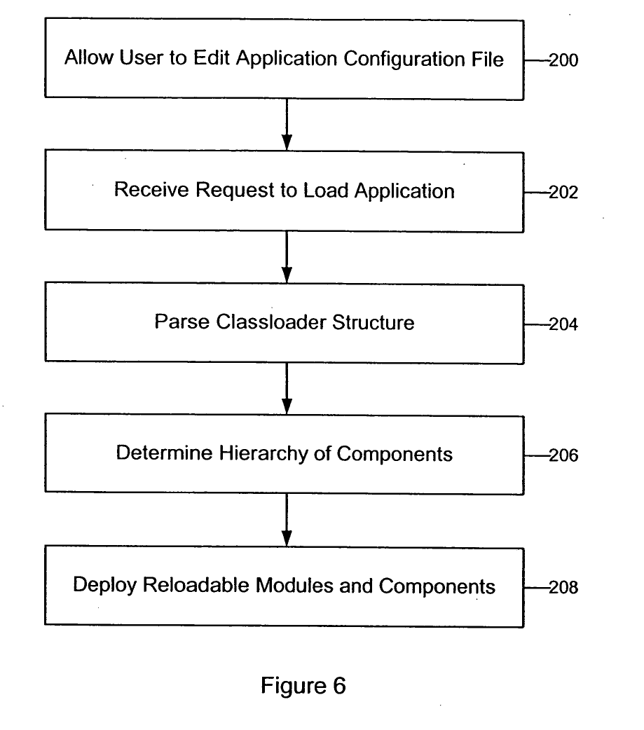

FIG. 6 illustrates the method used in one embodiment of the invention by the application server to construct the application container. An initial step 200, which can be performed at any time, is to allow the software developer to the edit the application configuration file, which will then determine the hierarchy of modules to be loaded. Then, in step 202, the application server initially receives a request for loading application components, usually from a client machine although applications may be executed on the same machine on which the application server itself resides. In step 204, the application server parses the configuration or control file (in one embodiment the application deployment descriptor file, for example in a WebLogic environment the weblogic-application.xml file) which contains the classloader hierarchy. The classes, modules, and other application components specified within the control file are recognized by the application server. In step 206, the application server proceeds to retrieve the specified application components from a computer readable medium (memory, disk, or other storage) in a manner consistent with the tag layout (i.e. the hierarchy) in the control file. In step 208, the application server then constructs the application container with the application components in the order in which they were retrieved, resulting in a hierarchical classloader structure in the newly constructed application.

Individual EJB Classloader for Implementation Classes

Embodiments of the invention may also be used to provide individual EJB classloaders for implementation classes. In accordance with one embodiment, the server (for example WebLogic Server) allows the developer or the system to reload individual EJB modules without forcing other modules to be reloaded at the same time and having to redeploy the entire EJB module. Since EJB classes are invoked through an interface, it is possible to load individual EJB implementation classes in their own classloader. In this manner, these classes can be reloaded individually without having to redeploy the entire EJB module.

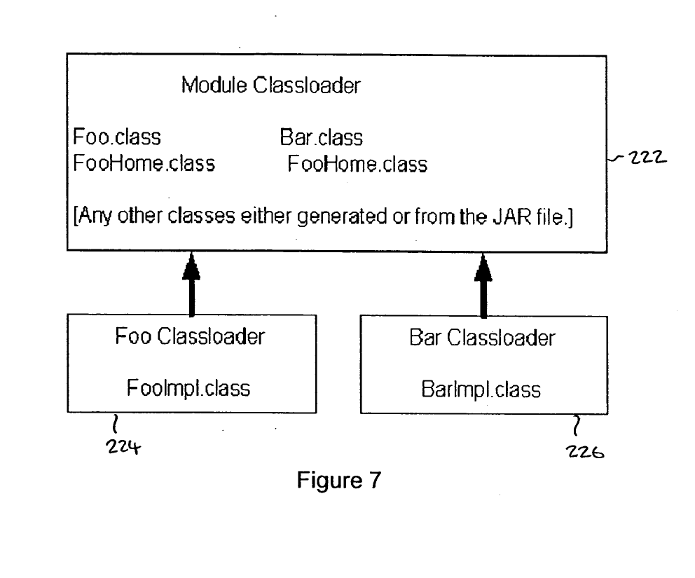

FIG. 7 shows a diagram of what the classloader hierarchy for a single EJB module looks like. In the example shown in FIG. 7, the module 222 contains two EJBs (“Foo” 224 and “Bar” 226 in this example). This represents a sub-tree of the general application hierarchy described in the previous section. To perform an incremental update (partial upgrade), the developer can use the following command line to redeploy myejb/foo.class:

java weblogic.Deployer -adminurl url -user user -password password
-name myapp -redeploy myejb/foo.class

After the redeploy command, the developer can then provide a list of files relative to the root of the exploded application that they want to update. This might be the path to a specific element (as above), or a module, or any set of elements and modules. For example, the developer can use the following command to redeploy anotherejb:

java weblogic.Deployer -adminurl url -user user -password password
-name myapp -redeploy mywar myejb/foo.class anotherejb

Given a set of files to be updated, the system tries to figure out the minimum set of things it needs to redeploy. Redeploying only an EJB impl class causes only that class to be redeployed. If the developer specifies the whole EJB (in the above example, anotherejb) or if they change and update the EJB home interface, the entire EJB module must be redeployed. Depending on the classloader hierarchy, this may lead to other modules being redeployed. Specifically, if other modules share the EJB classloader or are loaded into a classloader that is a child to the EJB's classloader, (as in our standard classloader module) then those modules are also reloaded.

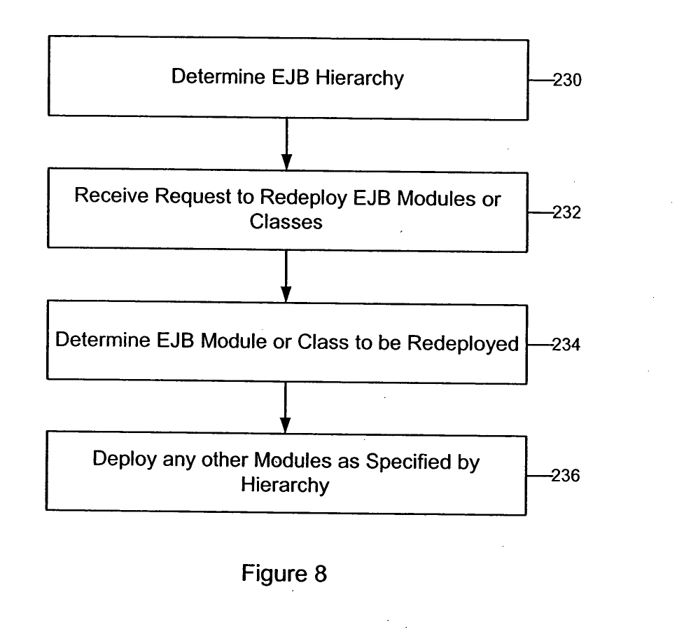

FIG. 8 illustrates the method used in accordance with an embodiment of the invention to allow reloading of EJB implementations. In step 230, the system allows the developer to specify EJB's and/or classes that comprise an EJB module hierarchy. This is performed by creating and storing the hierarchy of reloaders in an appropriate configuration file, as described above. In step 232, the system later receives a request or instruction to redeploy a particular class or module, for example an EJB. In step 234, the system parses the classloader hierarchy to determine which modules or classes should be redeployed to satisfy the request. In step 236, the necessary modules, including EJB's and/or classes are redeployed as specified by the classloader hierarchy.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, it will be evident that the examples of how a classloader hierarchy may be used are given for purposed of illustration and the invention is not limited to such examples. It will also be evident that while the examples described herein illustrate how the invention maybe used in a WebLogic environment, other application servers may use and benefit from the invention. It will also be evident that while the embodiments describe in detail the use of a classloader hierarchy with an EJB application, the methods described may be used with other application types and with other J2EE applications, including those that comprise EJBs, JSPs, and Web applications, etc. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for loading software applications, comprising:
a server for executing an software application thereupon, wherein said software application has a number of modules associated therewith;
a control file associated with said software application, wherein said control file specifies a hierarchy of classloaders to be used with said modules;
a deployment mechanism that loads with said software application a selection of said classloaders according to the hierarchy specified by said control file; and,
wherein upon receiving a request to deploy any of said modules the system determines, according to said hierarchy, the minimum number of modules and/or additional modules necessary to deploy or redeploy the software application, and then deploys those modules.

2. The system of claim 1 further comprising a user interface that allows a software developer to specify a subset of said modules to be deployed.

3. The system of claim 1 wherein said modules are any of EJB components, classes, or implementations.

4. The system of claim 2 wherein said user interface allows the software developer to specify a redeploy command that instructs the system that said subset should be redeployed, wherein said redeploy command specifies an software application name and a module associated with the application.

5. The system of claim 4 wherein said redeploy command includes a list of modules relative to the root of the application to be deployed, for redeployment of said modules.

6. The system of claim 5 wherein the module is any of EJB components, class, or implementations.

7. The system of claim 6 wherein the module is a WAR file.

8. The system of claim 6 wherein the module is an EJB impl class.

9. The system of claim 6 wherein the module is an EJB, and wherein each of the classes within that module are redeployed.

10. The system of claim 1 wherein the server provides multiple EJB software applications, each with their own hierarchy of classloaders.

11. A method for loading application components, comprising the steps of:
providing an EJB software application thereupon, wherein said EJB software application has a number of modules associated therewith;
parsing a control file associated with said EJB software application, wherein said control file specifies a hierarchy of classloaders to be used with said modules;
deploying said EJB software application with a selection of said classloaders according to the hierarchy specified by said control file; and,
wherein upon receiving a request to deploy any of said modules, determining, according to said hierarchy, the minimum number of modules and/or additional modules necessary to deploy or redeploy the EJB software application, and then deploys those modules.

12. The method of claim 11 further comprising a user interface that allows a software developer to specify a subset of said modules to be deployed.

13. The method of claim 11 wherein said modules are any of EJB components, classes, or implementations.

14. The method of claim 12 wherein said user interface allows the software developer to specify a redeploy command that instructs the method that said subset should be redeployed, wherein said redeploy command specifies an EJB software application name and a module associated with the application.

15. The method of claim 14 wherein said redeploy command includes a list of modules relative to the root of the application to be deployed, for redeployment of said modules.

16. The method of claim 15 wherein the module is any of EJB components, class, or implementations.

17. The method of claim 16 wherein the module is a WAR file.

18. The method of claim 16 wherein the module is an EJB impl class.

19. The method of claim 16 wherein the module is an EJB, and wherein each of the classes within that module are redeployed.

20. The method of claim 11 wherein the server provides multiple EJB software applications, each with their own hierarchy of classloaders.

21. A computer readable medium including instructions stored thereon which when
executed cause the computer to perform the steps of
providing an EJB software application thereupon, wherein said EJB software application has a number of modules associated therewith;
parsing a control file associated with said EJB software application, wherein said control file specifies a hierarchy of classloaders to be used with said modules;
deploying said EJB software application a selection of said classloaders according to the hierarchy specified by said control file; and,
wherein upon receiving a request to deploy any of said modules, determining, according to said hierarchy, the minimum number of modules and/or additional modules necessary to deploy or redeploy the EJB software application, and then deploys those modules.

22. The computer readable medium of claim 21 further comprising a user interface that allows a software developer to specify a subset of said modules to be deployed.

23. The computer readable medium of claim 21 wherein said modules are any of EJB components, classes, or implementations.

24. The computer readable medium of claim 22 wherein said user interface allows the software developer to specify a redeploy command that instructs the system that said subset should be redeployed, wherein said redeploy command specifies an EJB software application name and a module associated with the application.

25. The computer readable medium of claim 24 wherein said redeploy command includes a list of modules relative to the root of the application to be deployed, for redeployment of said modules.

26. The computer readable medium of claim 25 wherein the module is any of EJB components, class, or implementations.

27. The computer readable medium of claim 26 wherein the module is a WAR file.

28. The computer readable medium of claim 26 wherein the module is an EJB impl class.

29. The computer readable medium of claim 26 wherein the module is an EJB, and wherein each of the classes within that module are redeployed.

30. The computer readable medium of claim 21 wherein the server provides multiple EJB software applications, each with their own hierarchy of classloaders.
